(19) United States
(12) Patent Application Publication
(10) Pub. No.: US 2016/0006909 A1
(43) Pub. Date: Jan. 7, 2016

(54) IMAGE CAPTURING MODULE FOR INCREASING ADHESION STRENGTH AND ASSEMBLY FLATNESS

(71) Applicant: LARVIEW TECHNOLOGIES CORP., TAOYUAN COUNTY (TW)

(72) Inventors: CHING-LUNG JAO, TAIPEI CITY (TW); CHIANG-YUAN CHUANG, TAIPEI CITY (TW); YU-TE CHOU, NEW TAIPEI CITY (TW)

(21) Appl. No.: 14/324,268

(22) Filed: Jul. 7, 2014

(51) Int. Cl. H04N 5/225

(52) U.S. Cl. CPC H04N 5/2252; H04N 5/2253

(57) ABSTRACT

An image capturing module includes an image sensing unit, a housing frame and an actuator structure. The image sensing unit includes a carrier substrate and an image sensing chip disposed on the carrier substrate and electrically connected to the carrier substrate. The housing frame is disposed on the carrier substrate through a surrounding adhesion structure to surround the image sensing chip. The surrounding adhesion structure includes a surrounding adhesive layer having a uniform thickness and a plurality of spherical particles having the same size. The surrounding adhesive layer is adhesively disposed between the carrier substrate and the housing frame, and each spherical particle is disposed between the carrier substrate and the housing frame and enclosed by the surrounding adhesive layer. The actuator structure includes a lens holder disposed on the housing frame and a movable lens assembly movably disposed inside the lens holder.

### BACKGROUND OF THE INVENTION

1. Field of the Invention

The instant disclosure relates to an image capturing module, and more particularly to an image capturing module for increasing adhesion strength and assembly flatness.

2. Description of Related Art

Recently, it becomes more and more popular for portable devices such as mobile phones or PDA to be equipped with an imaging module. Furthermore, since the market requires these portable devices to have more powerful functions and smaller sizes, it is necessary for the imaging module to generate high quality pictures and to be of small size accordingly. One improvement of picture quality is to increase the number of pixel. The pixel number of an imaging module has already increased from the VGA-level 30 pixels to 2, 3 or even 8 million pixels, which is now common in the market. Another improvement lies in the definition of the image. Thus, the imaging module of a portable device also develops from a fixed-focus mode to auto-focus mode or even optical zoom mode.

The auto-focus mode employs the principle of moving the lens in the imaging module suitably according to various distances of targets, whereby the optical image of the desired target can be focused correctly on an image sensor so as to generate a clear image. The common ways of activating the lens to move in the imaging module include activating by a stepping motor, piezoelectric motor and voice coil motor (VCM). However, when both the image sensor and the sensor housing are disposed on the same datum plane of the circuit board, the assembly tilt angle of the sensor housing relative to the image sensor would be increased, thus the image quality provided by the imaging module cannot be improved due to the increased assembly tilt angle.

### SUMMARY OF THE INVENTION

One aspect of the instant disclosure relates to an image capturing module for increasing adhesion strength and assembly flatness.

One of the embodiments of the instant disclosure provides an image capturing module for increasing adhesion strength and assembly flatness, comprising: an image sensing unit, a housing frame and an actuator structure. The image sensing unit includes a carrier substrate and an image sensing chip disposed on the carrier substrate and electrically connected to the carrier substrate. The housing frame is disposed on the carrier substrate through a surrounding adhesion structure to surround the image sensing chip, wherein the surrounding adhesion structure includes a surrounding adhesive layer having a uniform thickness and a plurality of spherical particles having the same size, the surrounding adhesive layer is adhesively disposed between the carrier substrate and the housing frame, and each spherical particle is disposed between the carrier substrate and the housing frame and enclosed by the surrounding adhesive layer. The actuator structure is disposed on the housing frame and above the image sensing chip, wherein the actuator structure includes a lens holder disposed on the housing frame and a movable lens assembly movably disposed inside the lens holder.

Another one of the embodiments of the instant disclosure provides an image capturing module for increasing adhesion strength and assembly flatness, comprising: an image sensing unit, a housing frame and a lens structure. The image sensing unit includes a carrier substrate and an image sensing chip disposed on the carrier substrate and electrically connected to the carrier substrate. The housing frame is disposed on the carrier substrate through a surrounding adhesion structure to surround the image sensing chip, wherein the surrounding adhesion structure includes a surrounding adhesive layer having a uniform thickness and a plurality of spherical particles having the same size, the surrounding adhesive layer is adhesively disposed between the carrier substrate and the housing frame, and each spherical particle is disposed between the carrier substrate and the housing frame and enclosed by the surrounding adhesive layer. The lens structure is disposed on the housing frame and above the image sensing chip, wherein the lens structure includes a lens holder disposed on the housing frame and a fixed lens assembly fixedly disposed inside the lens holder.

Yet another one of the embodiments of the instant disclosure provides an image capturing module for increasing adhesion strength and assembly flatness, comprising: an image sensing unit, a housing frame and an optical auxiliary structure. The image sensing unit includes a carrier substrate and an image sensing chip disposed on the carrier substrate and electrically connected to the carrier substrate. The housing frame is disposed on the carrier substrate through a surrounding adhesion structure to surround the image sensing chip, wherein the surrounding adhesion structure includes a surrounding adhesive layer having a uniform thickness and a plurality of spherical particles having the same size, the surrounding adhesive layer is adhesively disposed between the carrier substrate and the housing frame, and each spherical particle is disposed between the carrier substrate and the housing frame and enclosed by the surrounding adhesive layer. The optical auxiliary structure is disposed on the housing frame and above the image sensing chip, wherein the optical auxiliary structure includes a lens holder disposed on the housing frame and a lens assembly disposed inside the lens holder.

Therefore, when the housing frame is disposed on the carrier substrate through a surrounding adhesion structure to surround the image sensing chip, the assembly tilt angle of the movable lens assembly or the fixed lens assembly relative to an image sensing area on the top side of the image sensing chip can be reduced through the surrounding adhesion structure having the same thickness due to the design of “the surrounding adhesion structure includes a surrounding adhesive layer having a uniform thickness and a plurality of spherical particles having the same size, the surrounding adhesive layer is adhesively disposed between the carrier substrate and the housing frame, and each spherical particle is disposed between the carrier substrate and the housing frame and enclosed by the surrounding adhesive layer”. Therefore, the assembly flatness of the movable lens assembly or the fixed lens assembly relative to the image sensing chip can be increased assuredly. It is worth mentioning that the gap between carrier substrate and the housing frame can be increased through the spherical particles, thus the content of the surrounding adhesive layer adhesively disposed between the carrier substrate and the housing frame can be increased, so as to increase the adhesion strength between the carrier substrate and the housing frame.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows a lateral, cross-sectional, schematic view of the image capturing module for increasing adhesion strength and assembly flatness according to the first embodiment of the instant disclosure;

FIG. 2 shows an enlarged view taken on part A of FIG. 1; and

FIG. 3 shows a lateral, cross-sectional, schematic view of the image capturing module for increasing adhesion strength and assembly flatness according to the second embodiment of the instant disclosure.

### DETAILED DESCRIPTION OF THE PREFERRED EMBODIMENTS

The embodiments of “an image capturing module for increasing adhesion strength and assembly flatness” of the instant disclosure are described. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

### First Embodiment

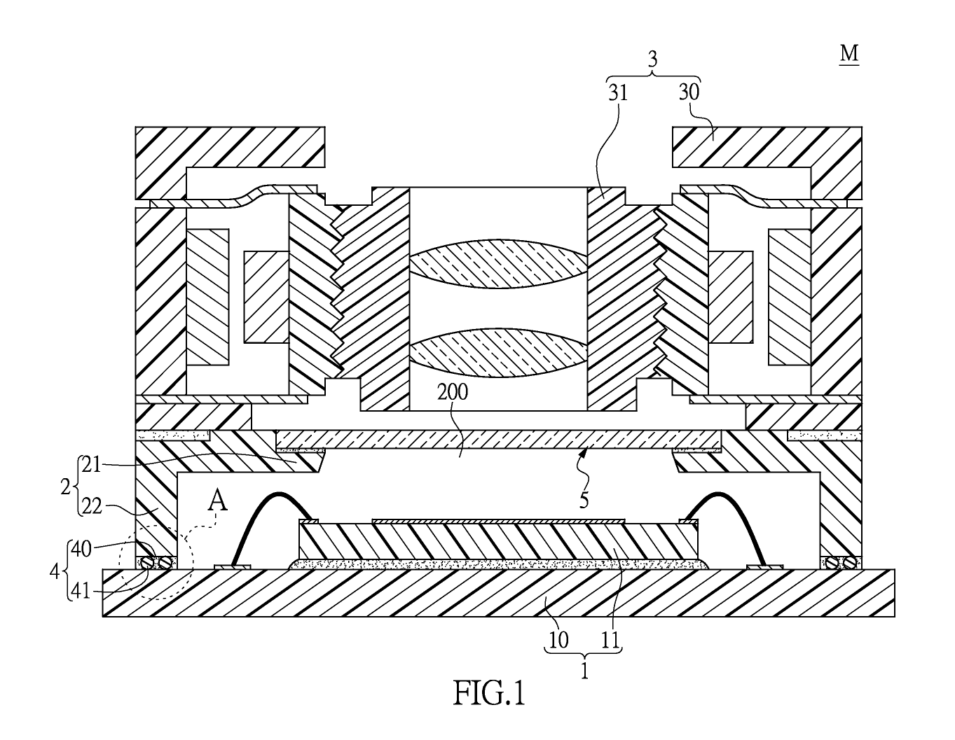

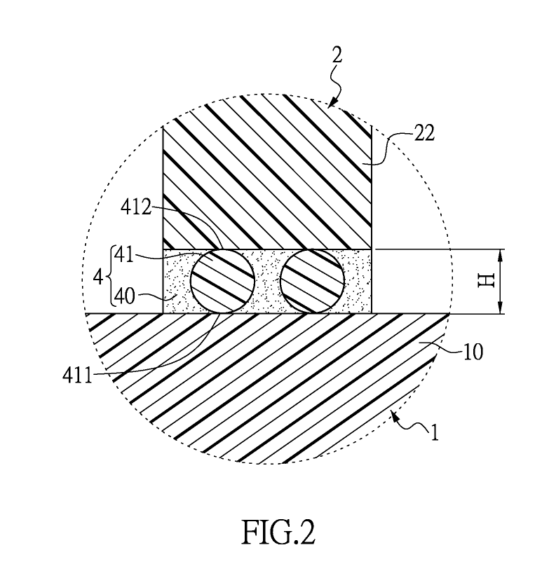

Referring to FIG. 1 and FIG. 2, FIG. 2 is an enlarged view taken on part A of FIG. 1, the first embodiment of the instant disclosure provides an image capturing module M for increasing adhesion strength and assembly flatness, comprising: an image sensing unit 1, a housing frame 2 and an actuator structure 3 (i.e., an optical auxiliary structure).

First, as shown in FIG. 1, the image sensing unit 1 includes a carrier substrate 10 (or a carrying substrate) and an image sensing chip 11 disposed on the carrier substrate 10 and electrically connected to the carrier substrate 10. For example, the image sensing chip 11 may be a CMOS (Complementary Metal-Oxide-Semiconductor) image sensing chip, and the image sensing chip 11 can be adhesively disposed on the carrier substrate 10 through any type of adhesive material (not labeled) such as UV adhesive glue, thermosetting glue or oven curing glue etc. In addition, the carrier substrate 10 may be a circuit substrate having a plurality of conductive pads (not labeled) disposed on the top surface of the circuit substrate, and the image sensing chip 11 has a plurality of conductive pads (not labeled) disposed on the top surface of the image sensing chip 11. Each conductive pad (not labeled) of the image sensing chip 11 can be electrically connected to the corresponding conductive pad (not labeled) of the carrier substrate 10 through a corresponding conductive wire (not labeled), thus the image sensing chip 11 can be electrically connected with the carrier substrate 10 through the conductive wires (not labeled).

Moreover, as shown in FIG. 1, the housing frame 2 is disposed on the carrier substrate 10 to surround the image sensing chip 11. The actuator structure 3 is disposed on the housing frame 2 and above the image sensing chip 11, and the actuator structure 3 includes a lens holder 30 disposed on the housing frame 2 and a movable lens assembly 31 movably disposed inside the lens holder 30. For example, the housing frame 2 can be adhesively disposed on the carrier substrate 10 through any type of adhesive material (not labeled) such as UV adhesive glue, thermosetting glue or oven curing glue etc., and the lens holder 30 also can be adhesively disposed on the housing frame 2 through any type of adhesive material (not labeled) such as UV adhesive glue, thermosetting glue or oven curing glue etc, and the movable lens assembly 31 may be an optical lens group that is composed of a plurality of optical lenses (not labeled). In addition, it is worth mentioning that the actuator structure 3 may be a voice coil motor actuator, but the voice coil motor actuator used in the first embodiment is merely an example and is not meant to limit the instant disclosure.

More precisely, referring to FIG. 1 and FIG. 2, the housing frame 2 is disposed on the carrier substrate 10 through a surrounding adhesion structure 4 to surround the image sensing chip 11. The surrounding adhesion structure 4 includes a surrounding adhesive layer 40 having a uniform thickness

H and a plurality of spherical particles 41 having the same size, the surrounding adhesive layer 40 is adhesively disposed between the carrier substrate 10 and the housing frame 2, and each spherical particle 41 is disposed between the carrier substrate 10 and the housing frame 2 and enclosed by the surrounding adhesive layer 40.

More precisely, referring to FIG. 1 and FIG. 2, the image capturing module M further comprises an optical filter 5 disposed on the housing frame 2 and between the image sensing chip 11 and the movable lens assembly 31. In addition, the housing frame 2 has a top opening 200 disposed on the top side thereof and between the image sensing chip 11 and the movable lens assembly 31, and the top opening 200 of the housing frame 2 is enclosed by the optical filter 5.

More precisely, as shown in FIG. 1, the housing frame 2 has a surrounding support portion 21 for supporting the optical filter 5 and the actuator structure 3 and a surrounding connection portion 22 downwardly extended from the surrounding support portion 21, and the surrounding adhesion structure 4 is adhesively disposed between the carrier substrate 10 and the surrounding connection portion 22 of the housing frame 2. In addition, referring to FIG. 1 and FIG. 2, the spherical particles 41 are horizontally disposed on the carrier substrate 10, thus each spherical particle 41 has a bottommost side 411 and a topmost side 412 respectively abutted against the carrier substrate 10 and the surrounding connection portion 22 of the housing frame 2, and the spherical particles 41 may be plastic balls having the same diameter or glass balls having the same diameter.

### Second Embodiment

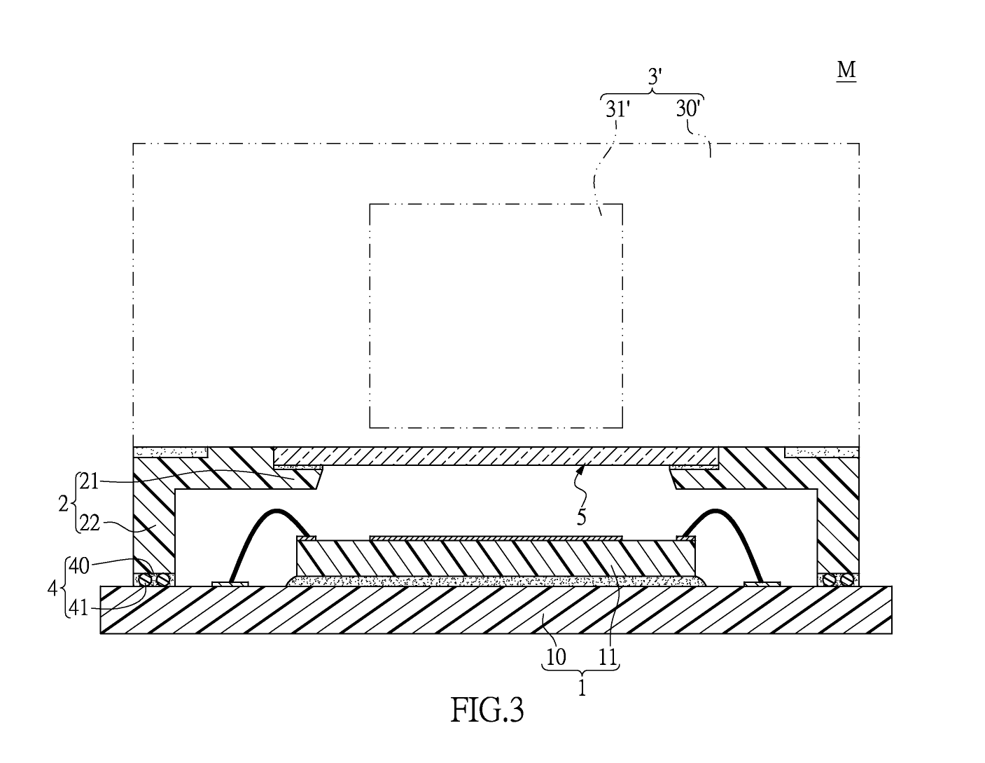

Referring to FIG. 3, the second embodiment of the instant disclosure provides an image capturing module M for increasing adhesion strength and assembly flatness, comprising: an image sensing unit 1, a housing frame 2 and a lens structure 3′ (i.e., an optical auxiliary structure). The image sensing unit 1 includes a carrier substrate 10 and an image sensing chip 11 disposed on the carrier substrate 10 and electrically connected to the carrier substrate 10. The housing frame 2 is disposed on the carrier substrate 10 through a surrounding adhesion structure 4 to surround the image sensing chip 11. The surrounding adhesion structure 4 includes a surrounding adhesive layer 40 having a uniform thickness H and a plurality of spherical particles 41 having the same size, the surrounding adhesive layer 40 is adhesively disposed between the carrier substrate 10 and the housing frame 2, and each spherical particle 41 is disposed between the carrier substrate 10 and the housing frame 2 and enclosed by the surrounding adhesive layer 10.

Comparing FIG. 3 with FIG. 1, the difference between the second embodiment and the first embodiment is as follows: in the second embodiment, the lens structure 3′ is disposed on the housing frame 2 and above the image sensing chip 11, and the lens structure 3′ includes a lens holder 30′ disposed on the housing frame 2 and a fixed lens assembly 31′ fixedly disposed inside the lens holder 30′. More precisely, the optical filter 5 is disposed on the housing frame 2 and between the image sensing chip 11 and the fixed lens assembly 31′, and the housing frame 2 has a top opening 200 disposed on the top side thereof and between the image sensing chip 11 and the fixed lens assembly 31′. In addition, the housing frame 2 has a surrounding support portion 21 for supporting the optical filter 5 and the lens structure 3′ and a surrounding connection portion 22 downwardly extended from the surrounding support portion 21.

Hence, the optical auxiliary structure of the instant disclosure may be an actuator structure 3 including a movable lens assembly 31 (as shown in the first embodiment) or a lens structure 3′ including a fixed lens assembly 31′ according to different requirements, but it is merely an example and is not meant to limit the instant disclosure.

In conclusion, when the housing frame 2 is disposed on the carrier substrate 10 through a surrounding adhesion structure 4 to surround the image sensing chip 11, the assembly tilt angle of the movable lens assembly 31 or the fixed lens assembly 31′ relative to an image sensing area on the top side of the image sensing chip 11 can be reduced through the surrounding adhesion structure 4 having the same thickness H due to the design of “the surrounding adhesion structure 4 includes a surrounding adhesive layer 40 having a uniform thickness H and a plurality of spherical particles 41 having the same size, the surrounding adhesive layer 40 is adhesively disposed between the carrier substrate 10 and the surrounding connection portion 22 of the housing frame 2, and each spherical particle 41 is disposed between the carrier substrate 10 and the surrounding connection portion 22 of the housing frame 2 and enclosed by the surrounding adhesive layer 40”. Therefore, the assembly flatness of the movable lens assembly 31 or the fixed lens assembly 31′ relative to the image sensing chip 11 can be increased assuredly. It is worth mentioning that the gap between carrier substrate 10 and the surrounding connection portion 22 of the housing frame 2 can be increased through the spherical particles 41, thus the content of the surrounding adhesive layer 40 adhesively disposed between the carrier substrate 10 and the surrounding connection portion 22 of the housing frame 2 can be increased, so as to increase the adhesion strength between the carrier substrate 10 and the surrounding connection portion 22 of the housing frame 2.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. An image capturing module, comprising:
an image sensing unit including a carrier substrate and an image sensing chip disposed on the carrier substrate and electrically connected to the carrier substrate;
a housing frame disposed on the carrier substrate through a surrounding adhesion structure to surround the image sensing chip, wherein the surrounding adhesion structure includes a surrounding adhesive layer having a uniform thickness and a plurality of spherical particles having the same size, the surrounding adhesive layer is adhesively disposed between the carrier substrate and the housing frame, and each spherical particle is disposed between the carrier substrate and the housing frame and enclosed by the surrounding adhesive layer; and
an actuator structure disposed on the housing frame and above the image sensing chip, wherein the actuator structure includes a lens holder disposed on the housing frame and a movable lens assembly movably disposed inside the lens holder.

2. The image capturing module of claim 1, further comprising: an optical filter disposed on the housing frame and between the image sensing chip and the movable lens assembly, wherein the housing frame has a top opening disposed on the top side thereof and between the image sensing chip and the movable lens assembly, and the top opening of the housing frame is enclosed by the optical filter.

3. The image capturing module of claim 2, wherein the housing frame has a surrounding support portion for supporting the optical filter and the actuator structure and a surrounding connection portion downwardly extended from the surrounding support portion, and the surrounding adhesion structure is adhesively disposed between the carrier substrate and the surrounding connection portion of the housing frame.

4. The image capturing module of claim 3, wherein the spherical particles are horizontally disposed on the carrier substrate, each spherical particle has a bottommost side and a topmost side respectively abutted against the carrier substrate and the surrounding connection portion of the housing frame, and the spherical particles are plastic balls or glass balls having the same diameter.

5. An image capturing module, comprising:
an image sensing unit including a carrier substrate and an image sensing chip disposed on the carrier substrate and electrically connected to the carrier substrate;
a housing frame disposed on the carrier substrate through a surrounding adhesion structure to surround the image sensing chip, wherein the surrounding adhesion structure includes a surrounding adhesive layer having a uniform thickness and a plurality of spherical particles having the same size, the surrounding adhesive layer is adhesively disposed between the carrier substrate and the housing frame, and each spherical particle is disposed between the carrier substrate and the housing frame and enclosed by the surrounding adhesive layer; and
a lens structure disposed on the housing frame and above the image sensing chip, wherein the lens structure includes a lens holder disposed on the housing frame and a fixed lens assembly fixedly disposed inside the lens holder.

6. The image capturing module of claim 5, further comprising: an optical filter disposed on the housing frame and between the image sensing chip and the fixed lens assembly, wherein the housing frame has a top opening disposed on the top side thereof and between the image sensing chip and the fixed lens assembly, and the top opening of the housing frame is enclosed by the optical filter.

7. The image capturing module of claim 6, wherein the housing frame has a surrounding support portion for supporting the optical filter and the lens structure and a surrounding connection portion downwardly extended from the surrounding support portion, and the surrounding adhesion structure is adhesively disposed between the carrier substrate and the surrounding connection portion of the housing frame.

8. The image capturing module of claim 7, wherein the spherical particles are horizontally disposed on the carrier substrate, each spherical particle has a bottommost side and a topmost side respectively abutted against the carrier substrate and the surrounding connection portion of the housing frame, and the spherical particles are plastic balls or glass balls having the same diameter.

9. An image capturing module, comprising:
an image sensing unit including a carrier substrate and an image sensing chip disposed on the carrier substrate and electrically connected to the carrier substrate;
a housing frame disposed on the carrier substrate through a surrounding adhesion structure to surround the image sensing chip, wherein the surrounding adhesion structure includes a surrounding adhesive layer having a uniform thickness and a plurality of spherical particles having the same size, the surrounding adhesive layer is adhesively disposed between the carrier substrate and the housing frame, and each spherical particle is disposed between the carrier substrate and the housing frame and enclosed by the surrounding adhesive layer; and
an optical auxiliary structure disposed on the housing frame and above the image sensing chip, wherein the optical auxiliary structure includes a lens holder disposed on the housing frame and a lens assembly disposed inside the lens holder.

10. The image capturing module of claim 9, further comprising: an optical filter disposed on the housing frame and between the image sensing chip and the lens assembly, wherein the housing frame has a top opening disposed on the top side thereof and between the image sensing chip and the lens assembly, and the top opening of the housing frame is enclosed by the optical filter, wherein the housing frame has a surrounding support portion for supporting the optical filter and the optical auxiliary structure and a surrounding connection portion downwardly extended from the surrounding support portion, and the surrounding adhesion structure is adhesively disposed between the carrier substrate and the surrounding connection portion of the housing frame, wherein the spherical particles are horizontally disposed on the carrier substrate, each spherical particle has a bottommost side and a topmost side respectively abutted against the carrier substrate and the surrounding connection portion of the housing frame, and the spherical particles are plastic balls or glass balls having the same diameter.
